(19) United States
(12) Patent Application Publication
(10) Pub. No.: US 2026/0023724 A1
(43) Pub. Date: Jan. 22, 2026

(54) INTERACTION-BASED DATA GOVERNANCE

(71) Applicant: Capital One Services, LLC, McLean, VA (US)

(72) Inventors: Ayaz MEHMANI, Teaneck, NJ (US); Ruoyu SHAO, Allen, TX (US); Nilou ABBAS, Keller, TX (US)

(21) Appl. No.: 18/778,831

(22) Filed: Jul. 19, 2024

(51) Int. Cl. G06F 16/21; G06F 11/07; G06F 11/34

(52) U.S. Cl. CPC G06F 16/213; G06F 11/0793; G06F 11/3409; G06F 2201/81

(57) ABSTRACT

A system for interaction-based data governance may obtain interaction information associated with a data structure in a plurality of data structures. The interaction information may be associated with user interactions with the data structure enabled using a large language model (LLM). The system may determine a metric associated with the data structure based on the interaction information associated with the user interactions. The system may perform a data governance action associated with the data structure based on the metric associated with the data structure.

### BACKGROUND

“Data governance” refers to management of availability, usability, integrity, and security of data. In general, data governance encompasses processes, policies, standards, and metrics that are used to provide effective and efficient use of information. Components of data governance may include data quality, data management, data policies, data stewardship, data security, compliance, data architecture, or metadata management, among other examples. Effective data governance can serve to enable an entity (e.g., an organization) to improve decision making, improve operational efficiency, comply with regulations, or protect sensitive information, among other examples.

### SUMMARY

Some implementations described herein relate to a system for interaction-based data governance. The system may include one or more memories and one or more processors communicatively coupled to the one or more memories. The one or more processors may be configured to obtain interaction information associated with a data structure in a plurality of data structures, wherein the interaction information is associated with user interactions with the data structure enabled using a large language model (LLM). The one or more processors may be configured to determine a metric associated with the data structure based on the interaction information associated with the user interactions. The one or more processors may be configured to perform a data governance action associated with the data structure based on the metric associated with the data structure.

Some implementations described herein relate to a method for interaction-based data governance. The method may include obtaining, by a system, user input associated with identifying one or more data structures, of a plurality of data structures, that store data requested by a user. The method may include identifying, by the system and using an LLM, a data structure based on the user input. The method may include generating, by the system and using the LLM, a query associated with the data structure based on the user input. The method may include obtaining, by the system, interaction information associated with the data structure, wherein the interaction information includes information associated with the user input, the query, or information associated with the data structure. The method may include determining, by the system and based on the interaction information, a metric associated with the data structure. The method may include performing, by the system and based on the metric, a data governance action associated with the data structure.

Some implementations described herein relate to a non-transitory computer-readable medium that stores a set of instructions. The set of instructions, when executed by one or more processors of a system, may cause the system to obtain interaction information associated with a data structure in a plurality of data structures, wherein the interaction information is obtained based on one or more user interactions with the data structure that are associated with outputs of an LLM. The set of instructions, when executed by one or more processors of the system, may cause the system to compute, based on the interaction information, a metric associated with the data structure, wherein the metric is associated with a usage rate of the data structure. The set of instructions, when executed by one or more processors of the system, may cause the system to cause a data governance action, associated with the data structure, to be performed based on a determination of whether the metric satisfies a threshold.

### BRIEF DESCRIPTION OF THE DRAWINGS

FIGS. 1A and 1B are diagrams of an example associated with interaction-based data governance, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with interaction-based data governance, in accordance with some embodiments of the present disclosure.

FIG. 4 is a flowchart of an example process associated with interaction-based data governance, in accordance with some embodiments of the present disclosure.

### DETAILED DESCRIPTION

The following detailed description of example implementations refers to the accompanying drawings. The same reference numbers in different drawings may identify the same or similar elements.

Data governance becomes increasingly challenging as a number of users, diversity of applications, turnover in data ownership, or other operational characteristics associated with data governance increase. Additionally, a data architect tasked with performing data governance has a limited bandwidth to coordinate with a given user and, therefore, is oftentimes unaware of a context for a given data structure. This architect-centric paradigm can result in the emergence of data silos across an organization, which can result in potentially valuable datasets not being leveraged by users. Furthermore, turnover in data ownership creates increased reliance on legacy documentation and ad-hoc communication between users and the data architect, which is impractical. These types of issues can have significant implications with respect to data maintenance or performance of a model that relies on data maintained by an organization.

Some implementations described herein provide techniques and apparatuses for interaction-based data governance. In some implementations, a system may obtain interaction information associated with a data structure in a plurality of data structures. Here, the interaction information may be associated with user interactions with the data structure enabled using an LLM. The system may determine a metric associated with the data structure based on the interaction information associated with the user interactions, and may perform a data governance action associated with the data structure based on the metric associated with the data structure.

In some implementations, the techniques and apparatuses described herein provide an LLM-powered architecture that enables data governance to be performed based on user interaction with a given data structure. The user-centric design described herein enables user feedback to automatically and directly impact maintenance of a given data structure (e.g., without substantive input from a data architect or engineer). In this way, data governance can be automated and democratized so as to avoid the emergence of data silos and reduce unwanted data redundancy. As a result, system resources (e.g., memory) used for storing or maintaining a set of data structures can be reduced and/or used more efficiently. Further, the user-centric design described herein reduces reliance on a data architect with respect to data governance, thereby reducing a burden on the data architect, while also reducing a likelihood of error with respect to data governance. Additional details are provided below.

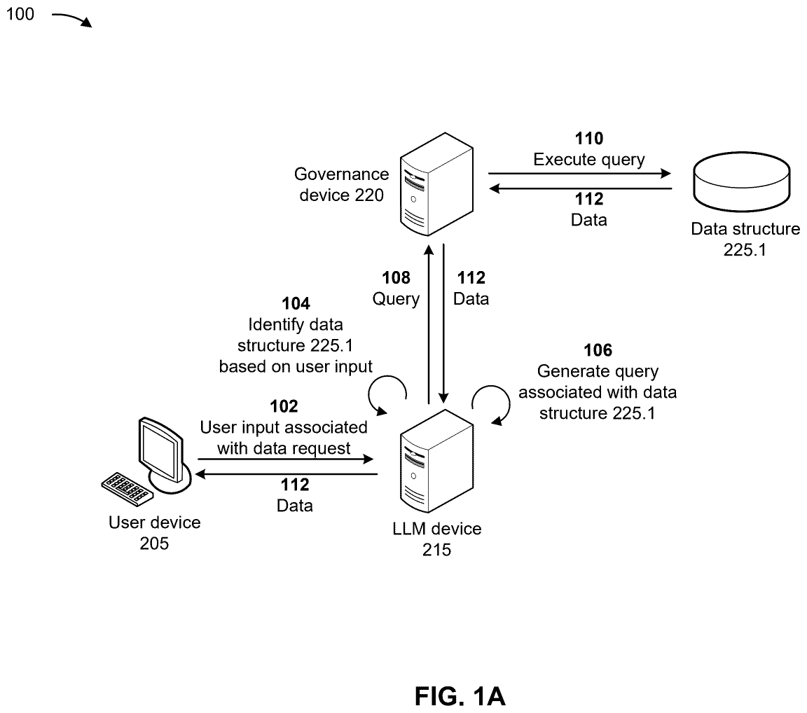

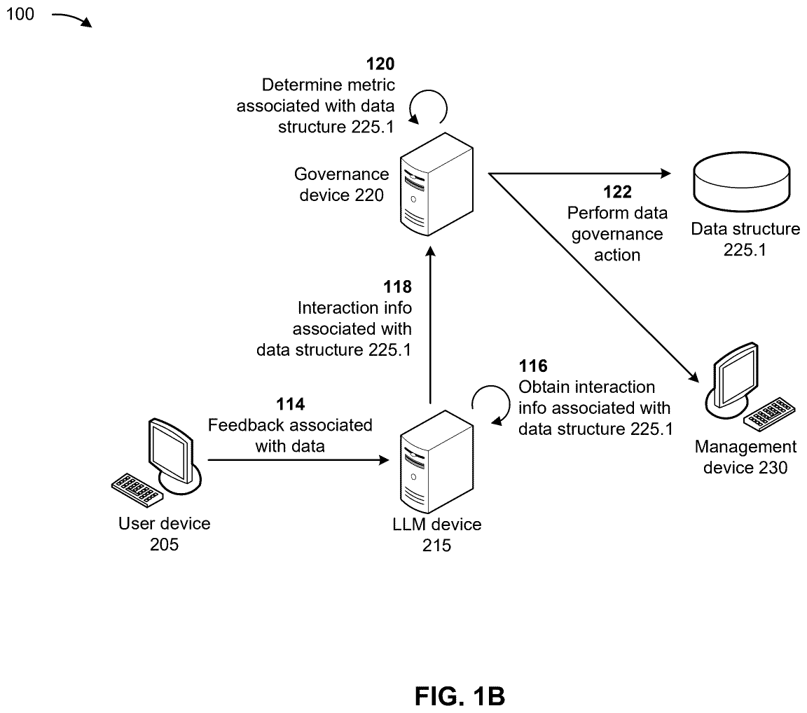

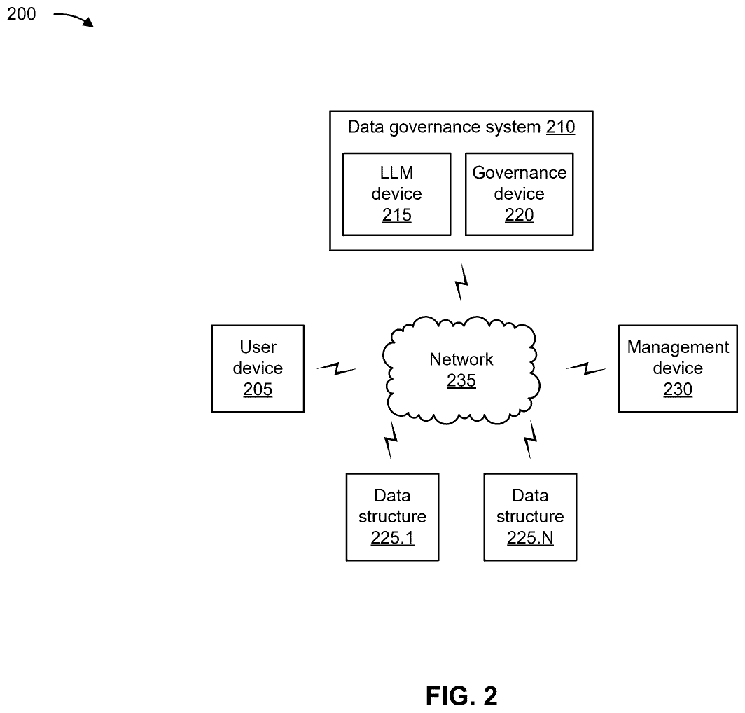

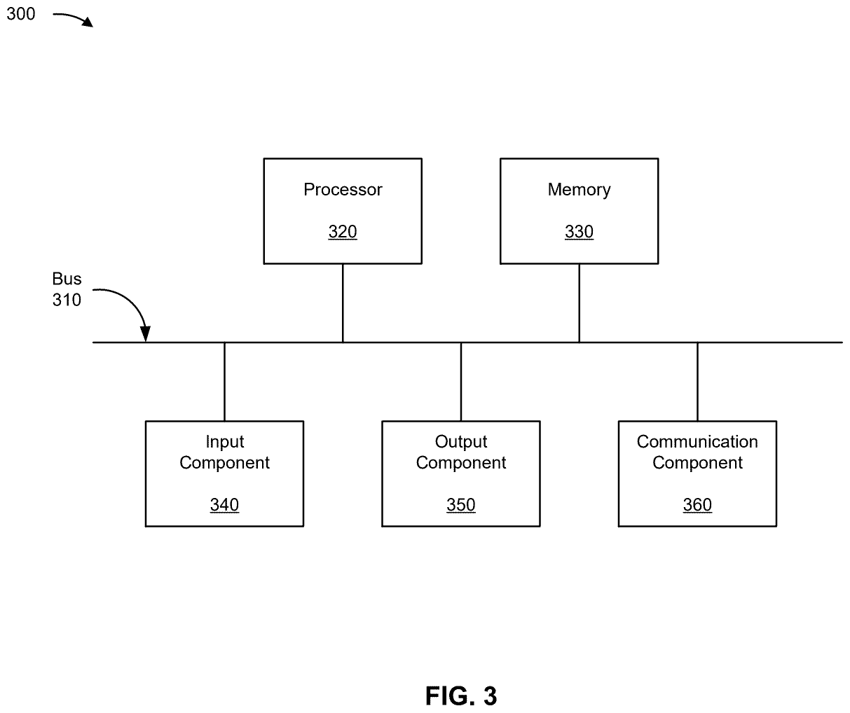

FIGS. 1A-1B are diagrams illustrating an example 100 associated with interaction-based data governance. As shown in FIGS. 1A-1B, example 100 includes a user device 205, an LLM device 215, a governance device 220 (which may collectively form a data governance system 210), one or more data structures 225 (e.g., including data structure 225.1), and a management device 230. These devices are described in more detail in connection with FIGS. 2 and 3.

As shown in FIG. 1A at reference 102, the LLM device 215 may obtain user input associated with data requested by the user. For example, a user of the user device 205 may provide input indicating a particular type of data, or data with a particular characteristic desired by the user (e.g., “I'm looking for a data table with the following characteristics . . . ”). The user input associated with identifying the data structure 225 that stores data requested by the user is referred to herein as a user request. In some implementations, the user input may be used in association with identifying a data structure 225 that stores data responsive to the user request, as described in further detail below.

As shown at reference 104, the LLM device 215 may identify a data structure 225 based on the user input and information associated with the plurality of data structures 225. That is, the LLM device 215 may identify, from a plurality of data structures 225 (e.g., a plurality of data structures 225 associated with the data governance system 210), a data structure 225 that potentially includes data responsive to the user request.

In some implementations, the LLM device 215 may be configured based on metadata associated with the plurality of data structures 225. In such a scenario, the LLM device 215 may store or have access to metadata associated with a plurality of data structures 225. Metadata associated with a given data structure 225 may include one or more items of data that describes or explains data included in the data structure 225. That is, metadata associated with a given data structure 225 includes data about data stored in the data structure 225. Notably, the metadata need not include actual data included in the data structure 225. Thus, the LLM device 215, in some implementations, does not receive or otherwise have access to data in a data structure 225 itself. Rather, the LLM device 215 receives or otherwise has access to metadata associated with the data structure 225. In this way, security of data structures 225 is improved or maintained (e.g., by eliminating a chance of a security breach through the LLM device 215).

In some implementations, to identify one or more data structures 225 relevant to a user request, the LLM device 215 may include a data structure identification model that is trained based on metadata associated with the plurality of data structures 225. The data structure identification model may be a model configured to process a user request to identify one or more data structures 225 that include data responsive to the user request. In some implementations, the data structure identification model may be configured or trained using one or more artificial intelligence (AI) techniques. The one or more AI techniques may include, for example, machine learning, a convolutional neural network, deep learning, language processing, or the like. For example, in some implementations, the one or more AI techniques may enable the LLM device 215 to compare data relating to the user request (e.g., one or more keywords, phrases, or the like) to data relating to the plurality of data structures 225 (e.g., metadata associated with the plurality of data structures 225) to identify one or more data structures 225 that may include data relevant to the user request. That is, in some implementations, the data structure identification model may receive the user request as input and provide information that identifies one or more data structures 225 as an output. Notably, types of data stored by a given data structure 225 may vary across the data structures 225. In practice, the data structure identification model may identify data structures 225 that store different types of data. In this way, data across different types of data structures 225 can be joined for utilization by the data governance system 210. In the example 100, the LLM device 215 identifies the data structure 225.1 as a data structure 225 that includes data responsive to the user request.

As shown at reference 106, the LLM device 215 may generate a query associated with the data structure 225 and based on the user input. In some implementations, the query generated by the LLM device 215 is a query that enables data responsive to the user request to be retrieved from the identified data structure 225. In some implementations, the query generated by the LLM device 215 includes code that, when executed, enables data relevant to the user request to be retrieved from one or more data structures 225 (e.g., one or more data structures 225 stored on one or more data structures 225). That is, the LLM device 215 may generate a query that, when executed by the data governance system 210, enables the data governance system 210 to retrieve (e.g., from one or more data structures 225) data that is responsive to the user request. In some implementations, the query is generated so as to enable data from the one or more data structures 225 identified by the LLM device 215 as storing data relevant to the user request to be retrieved.

In some implementations, the LLM device 215 may generate the query using a query generation model configured on the LLM device 215. In some implementations, the query generation model may be configured or trained using one or more AI techniques, such as machine learning, a convolutional neural network, deep learning, language processing, or the like. As an example, a given data structure 225 may be configured with a respective application programming interface (API) (e.g., a representational state transfer (REST) API) that is documented using a public API specification (e.g., the OpenAPI specification (OAS)). Here, the LLM device 215 may obtain the API specification (e.g., the specification for the API that conforms to the OAS) and may train the query generation model based on the API specification. For example, the query generation model may be trained to receive the user request and information that identifies the data structure 225 identified as storing data responsive to the user request, and to generate, as an output, code that enables retrieval of data relevant to the data request via the API associated with the data structure 225, with the code being generated according to the API specification.

As shown at reference 108, the LLM device 215 may provide the query by the LLM device 215 to the governance device 220. In this way, the data governance system 210 may obtain an LLM-generated query associated with retrieving data responsive to the user request.

As shown at reference 110, the governance device 220 may execute the query associated with the data structure 225 in association with retrieving data responsive to the user request. For example, the governance device 220 may execute the query so as to call an API associated with the identified data structure 225 (e.g., data structure 225.1 in example 100) that potentially stores the data responsive to the user request. In some implementations, as shown at reference 112, the data structure 225 may provide the data responsive to the user request to the governance device 220, the governance device 220 may provide the data responsive to the user request to the LLM device 215, and the LLM device 215 may provide the data responsive to the user request to the user device 205. For example, the data structure 225.1 may, in response to the API call associated with execution of the query generated by the LLM device 215 and executed by the governance device 220, provide a response including the data responsive to the user request to the governance device 220, the governance device 220 may provide the data to the LLM device 215, and the LLM device 215 may provide the data to the user device 205. In this way, the user may be provided with the data responsive to the user request using a query generated by the LLM device 215 based on the user input.

Notably, in the example shown in FIG. 1A, the user is provided with data responsive to the user request that is retrieved based on a query generated by the LLM device 215. In some implementations, the user may be provided with other or different information after providing the user request. For example, rather than or in addition to the data responsive to the user input, the LLM device 215 may provide the user with information associated with the data structure 225 identified by the LLM device 215 (e.g., so that the user can determine whether to query the identified data structure 225, so that the use can generate a query, or the like). As another example, rather than or in addition to the data responsive to the user input, the LLM device 215 may provide the user with the query generated by the LLM device 215 (e.g., so that the user can execute the query via the user device 205, so that the user can modify or add to the query generated by the LLM device 215, or the like).

As shown in FIG. 1B at reference 114, the LLM device 215 may receive user feedback associated with the data request. In one example, the user feedback may include feedback associated with the data provided in response to the user request (e.g., “This is not the data I asked for”, “This is okay but I also need . . . ”). Thus, in some implementations, the user feedback may include feedback, provided by the user via user input, that indicates user satisfaction with the data provided in response to the user request.

In some implementations, if the user is provided with information associated with the identified data structure 225 (e.g., information that identifies data structure 225.1 as the data structure 225 that includes data responsive to the user request), the user feedback may include feedback associated with the data structure 225 itself. For example, the user feedback may indicate a status of the data structure 225 (e.g., “This data table didn't work”) or another type of information associated with the identified data structure 225 (e.g., “I engaged more with another data table, using a previous but similar user request, than this data table”).

In some implementations, if the user is provided with the query generated by the LLM device 215, then the user feedback may include feedback associated with the query. For example, the user feedback may include an indication of a performance of the query (e.g., “This query worked perfectly,” “This query did not provide the data I wanted,” or the like).

In some implementations, the user feedback may include an additional user request, and the LLM device 215 may proceed with processing the additional user request in a manner similar to that described above with respect to FIG. 1A.

As shown at reference 116, the LLM device 215 may obtain interaction information associated with the data structure 225. For example, with respect to example 100, the LLM device 215 may obtain interaction information associated with the data structure 225 identified by the LLM device 215 (e.g., the data structure 225.1 in example 100).

Interaction information is information associated with one or more interactions with a data structure 225 as enabled using the LLM device 215. In general, interaction information associated with a given data structure 225 comprises information indicating, for example, whether the given data structure 225 is operational or is experiencing issues, a degree to which the given data structure 225 is or is not being queried, or another type of information indicative of interaction with the data structure 225. As a particular example, the interaction information may include user feedback associated with the data structure 225 (e.g., the user feedback as described above with respect to reference 114). As another example, the interaction information may include the query generated by the LLM device 215 (e.g., the query generated by the LLM device 215 as described above with respect to reference 106). As another example, the interaction information may include information associated with the data structure 225 itself (e.g., information that identifies the data structure 225 identified by the LLM device 215 as described above with respect to reference 104, metadata associated with the data structure 225 identified by the LLM device 215 as described above with respect to reference 104, or the like). In this way, interaction information can be maintained on a per-data-structure basis. In some implementations, the interaction information may be associated with a timestamp (e.g., such that a chronology of interaction information associated with a given data structure 225 can be maintained).

As shown at reference 118, the LLM device 215 may provide, and the governance device 220 may receive, the interaction information associated with the user interactions with the data structure 225 enabled using the LLM. In some implementations, the LLM device 215 may provide the interaction information. In some implementations, the LLM device 215 and/or the governance device 220 may store interaction information associated with one or more data structures 225 (e.g., such that a log of interaction information associated with a given data structure 225 is maintained over a period of time).

As shown at reference 120, the governance device 220 may determine a metric associated with the data structure 225 based on the interaction information associated with the user interactions. The metric associated with the data structure 225 is a metric that indicates a characteristic of the data structure 225, such as a usage of the data structure 225, a status of the data structure 225, or a performance associated with the data structure 225. In one particular example, the metric may in some implementations include a usage rate associated with the data structure 225 (e.g., a number of times that the data structure 225 was queried during a particular period of time). In another example, the metric may in some implementations include a failure rate associated with the data structure 225 (e.g., a number of times that data has not been successfully retrieved from the data structure 225 during a particular time period). In another example, the metric may in some implementations include a success rate associated with the data structure 225 (e.g., a percentage of occurrences that, when queried in response to user requests, data provided by the data structure 225 is responsive to user requests as indicated by user feedback).

In example 100, the governance device 220 determines one or more metrics associated with the data structure 225.1 based on interaction information associated with the data structure 225.1. In some implementations, the interaction information based on which the governance device 220 determines the metric may be interaction information obtained by the governance device 220 over a period of time (e.g., based on one or more user requests received by the data governance system 210 during the period of time that resulted in identification and/or querying of the data structure 225.1).

In some implementations, to determine a metric associated with a data structure 225, the governance device 220 may include a metric determination model. The metric determination model may be a model configured to process interaction information associated with the data structure 225 to compute one or more metrics associated with the data structure 225. In some implementations, the metric determination model may be configured or trained using one or more AI techniques. The one or more AI techniques may include, for example, machine learning, a convolutional neural network, deep learning, language processing, or the like. For example, in some implementations, the one or more AI techniques may enable the governance device 220 to compute one or more metrics associated with the data structure 225 based on interaction information associated with the data structure 225. That is, in some implementations, the metric determination model may receive interaction information as input and provide values of the one or more metrics as an output.

As shown at reference 122, the governance device 220 may perform a data governance action associated with the data structure 225 based on the metric associated with the data structure 225. A data governance action is an action associated with management of availability, usability, integrity, and security of data stored by the data structure 225. In some implementations, the data governance action may include providing an indication associated with a determination of whether the metric associated with the data structure 225 satisfies a threshold. For example, with respect to example 100, the governance device 220 may determine a usage rate associated with the data structure 225.1. The governance device 220 may then determine whether the usage rate satisfies a usage rate threshold, associated with the data structure 225.1, that is configured on the governance device 220. Here, if the governance device 220 determines that the usage rate fails to satisfy (e.g., is less than) the usage rate threshold, then the governance device 220 may provide (e.g., to the management device 230) an indication that the usage rate associated with the data structure 225.1 has dropped below the usage rate threshold. In some implementations, such an indication may serve to indicate that the data structure 225 has experienced some issue or error that has caused usage of the data structure 225.1 to decrease. As another example, with respect to example 100, the governance device 220 may determine a usage rate associated with the data structure 225.1. The governance device 220 may then determine whether the usage rate has changed, relative to a previously determined usage rate of the data structure 225.1, by an amount that satisfies a usage rate change threshold associated with the data structure 225.1. Here, if the governance device 220 determines that the usage rate change satisfies (e.g., is greater than or equal to) the usage rate change threshold, then the governance device 220 may provide (e.g., to the management device 230) an indication that the usage rate associated with the data structure 225.1 has changed by some amount that is indicative of the data structure 225 having experienced some issue or error that has caused usage of the data structure 225.1 to decrease.

Additionally, or alternatively, the data governance action may include modifying a configuration or schema associated with the data structure 225. That is, the data governance action may in some implementations include (e.g., automatically) modifying the data structure 225 (e.g., to address an issue that is detected by the governance device 220). For example, with respect to example 100, the governance device 220 may determine a failure rate associated with the data structure 225.1. The governance device 220 may then determine whether the failure rate satisfies a failure rate threshold, associated with the data structure 225.1, that is configured on the governance device 220. Here, if the governance device 220 determines that the failure rate satisfies (e.g., is greater than or equal to) the failure rate threshold, then the governance device 220 may modify a configuration or schema associated with the data structure 225.1 (e.g., so as to potentially resolve errors experienced when accessing the data structure 225.1).

Additionally, or alternatively, the data governance may include modifying a configuration associated with the LLM. That is, the data governance action may in some implementations include (e.g., automatically) tuning the LLM (e.g., in an attempt to increase a success rate of the data structure 225 by changing a manner in which the LLM operates). For example, with respect to example 100, the governance device 220 may determine a success rate associated with the data structure 225.1. The governance device 220 may then determine whether the success rate satisfies a success rate threshold, associated with the data structure 225.1, that is configured on the governance device 220. Here, if the governance device 220 determines that the success rate fails to satisfy (e.g., is less than) the success rate threshold (e.g., indicating that the data structure 225.1 is often misidentified as storing data responsive to user requests), then the governance device 220 may modify a configuration or setting of the LLM device 215 (e.g., so as to reduce misidentification of the data structure 225.1 by the LLM device 215).

In this way, the data governance system 210 may perform data governance based on user interaction with a given data structure 225 so as to enable user feedback and other interaction information to automatically and directly impact maintenance of the given data structure 225 (e.g., without substantive input from a data architect or engineer). As a result, data governance can be automated and democratized so as to avoid the emergence of data silos and reduce unwanted data redundancy, thereby reducing usage and improving efficiency with respect to resources (e.g., memory) used for storing or maintaining data structures 225.

As indicated above, FIGS. 1A-1B are provided as an example. Other examples may differ from what is described with regard to FIGS. 1A-1B.

FIG. 2 is a diagram of an example environment 200 in which systems and/or methods described herein may be implemented. As shown in FIG. 2, environment 200 may include a user device 205, a data governance system 210 comprising an LLM device 215 and a governance device 220, one or more data structures 225 (e.g., data structure 225.1 through data structure 225.N, where N≥1), a management device 230, and a network 235. Devices of environment 200 may interconnect via wired connections, wireless connections, or a combination of wired and wireless connections.

The user device 205 may include one or more devices capable of receiving, generating, storing, processing, and/or providing information associated with interaction-based data governance, as described elsewhere herein. The user device 205 may include a communication device and/or a computing device. For example, the user device 205 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The data governance system 210 may include one or more devices capable of receiving, generating, storing, processing, providing, and/or routing information associated with interaction-based data governance, as described elsewhere herein. The data governance system 210 may include a communication device and/or a computing device. For example, the data governance system 210 may include a server, such as an application server, a client server, a web server, a database server, a host server, a proxy server, a virtual server (e.g., executing on computing hardware), or a server in a cloud computing system. In some implementations, the data governance system 210 may include computing hardware used in a cloud computing environment. In some implementations, the data governance system 210 includes the LLM device 215 and the governance device 220.

The LLM device 215 may include one or more devices capable of receiving, generating, storing, processing, providing, and/or routing information associated with interaction-based data governance, as described elsewhere herein. The LLM device 215 may include a communication device and/or a computing device. For example, the LLM device 215 may include a server, such as an application server, a client server, a web server, a database server, a host server, a proxy server, a virtual server (e.g., executing on computing hardware), or a server in a cloud computing system. In some implementations, the LLM device 215 may include computing hardware used in a cloud computing environment.

The governance device 220 may include one or more devices capable of receiving, generating, storing, processing, providing, and/or routing information associated with interaction-based data governance, as described elsewhere herein. The governance device 220 may include a communication device and/or a computing device. For example, the governance device 220 may include a server, such as an application server, a client server, a web server, a database server, a host server, a proxy server, a virtual server (e.g., executing on computing hardware), or a server in a cloud computing system. In some implementations, the governance device 220 may include computing hardware used in a cloud computing environment.

A data structure 225 may include one or more devices capable of receiving, generating, storing, processing, and/or providing information (e.g., data) associated with interaction-based data governance, as described elsewhere herein. The data structure 225 may include a communication device and/or a computing device. For example, the data structure 225 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. In some implementations, the data structure 225 may include one or more databases.

The management device 230 may include one or more devices capable of receiving, generating, storing, processing, providing, and/or routing information associated with interaction-based data governance, as described elsewhere herein. The management device 230 may include a communication device and/or a computing device. For example, the management device 230 may include a server, such as an application server, a client server, a web server, a database server, a host server, a proxy server, a virtual server (e.g., executing on computing hardware), or a server in a cloud computing system. In some implementations, the management device 230 may include computing hardware used in a cloud computing environment.

The network 235 may include one or more wired and/or wireless networks. For example, the network 235 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 235 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with interaction-based data governance. The device 300 may correspond to the user device 205, the data governance system 210, the LLM device 215, the governance device 220, the data structure 225, and/or the management device 230. In some implementations, the user device 205, the data governance system 210, the LLM device 215, the governance device 220, the data structure 225, and/or the management device 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

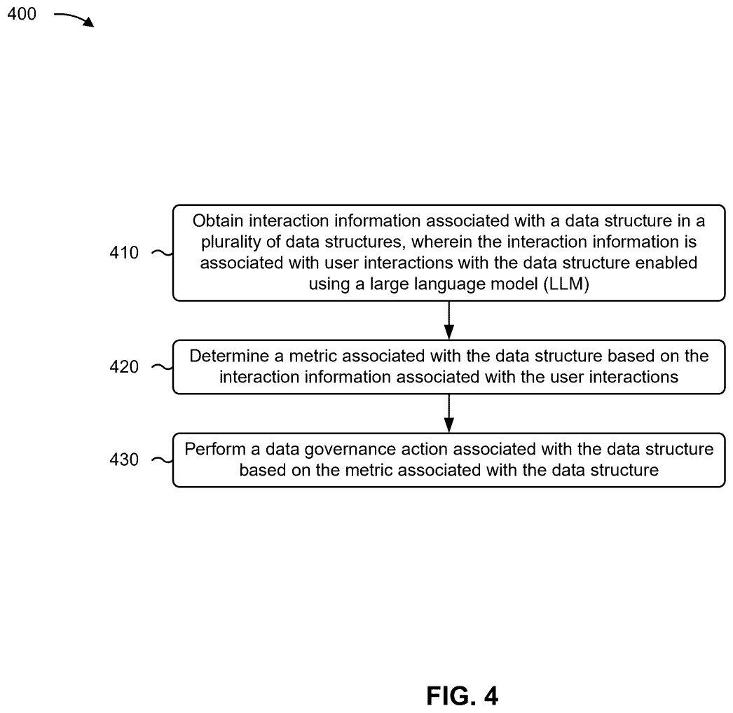

FIG. 4 is a flowchart of an example process 400 associated with interaction-based data governance. In some implementations, one or more process blocks of FIG. 4 may be performed by the data governance system 210. In some implementations, one or more process blocks of FIG. 4 may be performed by another device or a group of devices separate from or including the data governance system 210, such as the user device 205, LLM device 215, the governance device 220, the management device 230, and/or the data structure 225. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining interaction information associated with a data structure in a plurality of data structures, wherein the interaction information is associated with user interactions with the data structure enabled using an LLM (block 410). For example, the data governance system 210 (e.g., using LLM device 215, governance device 220, processor 320, and/or memory 330) may obtain interaction information associated with a data structure in a plurality of data structures, wherein the interaction information is associated with user interactions with the data structure enabled using an LLM, as described above in connection with reference 114 of FIG. 1B. As an example, the governance device 220 may obtain interaction information associated with the data structure 225.1 based on a user request that results in identification of the data structure 225.1 as potentially storing data responsive to the user request.

As further shown in FIG. 4, process 400 may include determining a metric associated with the data structure based on the interaction information associated with the user interactions (block 420). For example, the data governance system 210 (e.g., using governance device 220, processor 320, and/or memory 330) may determine a metric associated with the data structure based on the interaction information associated with the user interactions, as described above in connection with reference 116 of FIG. 1B. As an example, the governance device 220 may determine a usage rate associated with the data structure 225.1 based on the interaction information.

As further shown in FIG. 4, process 400 may include performing a data governance action associated with the data structure based on the metric associated with the data structure (block 430). For example, the data governance system 210 (e.g., using governance device 220, processor 320, and/or memory 330) may perform a data governance action associated with the data structure based on the metric associated with the data structure, as described above in connection with reference 118 of FIG. 1B. As an example, the governance device 220 may determine that the usage rate associated with the data structure 225.1 fails to satisfy a usage rate threshold, and may provide an indication that the usage rate fails to the satisfy the usage rate threshold to the management device 230.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1B. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for interaction-based data governance, the system comprising:
one or more memories; and
one or more processors, coupled to the one or more memories, configured to:
identify, based on obtaining user input associated with data requested by a user and using a large language mode (LLM), a data structure of a plurality of data structures, wherein the data structure is identified based on metadata associated with the plurality of data structures and independent from actual data stored in the data structure;
obtain interaction information comprising one or more timestamps associated with one or more user interactions with the data structure;
determine, based on the interaction information and using a metric determination model associated with the plurality of data structures, a metric associated with the data structure; and
perform a data governance action associated with the data structure based on the metric associated with the data structure,
wherein the data governance action comprises at least one of:
automatically modifying a configuration or schema associated with the data structure to resolve one or more errors associated with the metric, or
automatically modifying a configuration associated with the LLM to reduce misidentification of the data structure by the LLM.

2. The system of claim 1,
wherein the one or more processors are further configured to:
generate a query associated with the data structure and based on the user input.

3. The system of claim 2,
wherein the one or more processors are further configured to:
provide data responsive to the query; and
receive user feedback associated with the data responsive to the query, wherein the interaction information includes at least one of the query, the user feedback, or information associated with the data structure.

4. The system of claim 1,
wherein the metric indicates a usage rate associated with the data structure.

5. The system of claim 4,
wherein the data governance action is performed based on a determination that the usage rate fails to satisfy a usage rate threshold.

6. The system of claim 4,
wherein the data governance action is performed based on a determination that a change in the usage rate satisfies a usage rate change threshold.

7. The system of claim 1,
wherein the data governance action further comprises providing an indication associated with a determination of whether the metric associated with the data structure satisfies a threshold.

8. The system of claim 1,
wherein the data governance action comprises automatically modifying the configuration or schema associated with the data structure.

9. The system of claim 1,
wherein the data governance action comprises automatically modifying the configuration associated with the LLM.

10. A method for interaction-based data governance, comprising:
obtaining, by a system, user input associated with data requested by a user;
identifying, by the system and using a large language model (LLM), a data structure, based on the user input, of a plurality of data structure, wherein the data structure is identified based on metadata associated with the plurality of data structures and independent from actual data stored in the data structure;
generating, by the system and using the LLM, a query associated with the data structure based on the user input;
obtaining, by the system, interaction information comprising one or more timestamps associated with one or more user interactions with the data structure;
determining, by the system, based on the interaction information, and using a metric determination model associated with the plurality of data structures, a metric associated with the data structure; and
performing, by the system and based on the metric, a data governance action associated with the data structure, wherein the data governance action comprises at least one of:
automatically modifying a configuration or schema associated with the data structure to resolve one or more errors associated with the metric, or
automatically modifying a configuration associated with the LLM to reduce a misidentification of the data structure by the LLM.

11. The method of claim 10, further comprising:
providing, based on the query, data stored by the data structure that is responsive to the query; and
receiving user feedback associated with the data responsive to the query, wherein the interaction information includes the user feedback.

12. The method of claim 10,
wherein the metric indicates a usage rate associated with the data structure.

13. The method of claim 12,
wherein the data governance action is performed based on a determination that the usage rate fails to satisfy a usage rate threshold.

14. The method of claim 12,
wherein the data governance action is performed based on a determination that a change in the usage rate satisfies a usage rate change threshold.

15. The method of claim 10,
wherein the data governance action further comprises providing an indication associated with a determination of whether the metric associated with the data structure satisfies a threshold.

16. The method of claim 10,
wherein the data governance action comprises automatically modifying the configuration or schema associated with the data structure.

17. The method of claim 10,
wherein the data governance action comprises automatically modifying the configuration associated with the LLM.

18. A non-transitory computer-readable medium storing a set of instructions, the set of instructions comprising:
one or more instructions that, when executed by one or more processors of a system, cause the system to:
identify, based on obtaining user input associated with data requested by a user and using a large language mode (LLM), a data structure of a plurality of data structures, wherein the data structure is identified based on metadata associated with the plurality of data structures and independent from actual data stored in the data structure;
obtain interaction information comprising one or more timestamps associated with one or more user interactions with the data structure;
compute, based on the interaction information and using a metric determination model associated with the plurality of data structures, a metric associated with the data structure, wherein the metric is associated with a usage rate of the data structure; and
cause a data governance action, associated with the data structure, to be performed based on a determination of whether the metric satisfies a threshold.

19. The non-transitory computer-readable medium of claim 18,
wherein the one or more instructions further cause the system to:
generate a query associated with the data structure based on the user input.

20. The non-transitory computer-readable medium of claim 19,
wherein the one or more instructions further cause the system to:
provide data responsive to the query; and
receive user feedback associated with the data responsive to the query, wherein the interaction information includes at least one of the query, the user feedback, or information associated with the data structure.
